(19) United States
(12) Patent Application Publication
(10) Pub. No.: US 2006/0285749 A1
(43) Pub. Date: Dec. 21, 2006

(54) User-initiated reporting of handwriting recognition errors over the internet

(75) Inventors: Frank J. Eisenhart, Seattle, WA (US); Aleksey V. Maykov, Redmond, WA (US); Ahmad A. Abdulkader, Woodinville, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/154,650

(22) Filed: Jun. 17, 2005

(51) Int. Cl. G06K 9/00; G09G 5/00

(52) U.S. Cl. 382/188; 345/179

(57) ABSTRACT

A user may initiate or confirm a process for reporting errors in handwriting recognition errors in a computer system. A user dialog is provided in which a user may select handwriting recognition errors to report and report the selected handwriting recognition errors via a handwriting recognition error report. The report may include selected handwriting recognition errors including ink samples, recognized text, corrected text and status. The handwriting recognition errors may further be categorized based on multiple parameters. The user may also include comments with the report.

### BACKGROUND

Many computer systems receive handwritten user input. For example, a user can write text in his/her own handwriting by moving a stylus across a digitizing surface (e.g., on a tablet PC). Movements of the stylus create a set of input curves representative of the user's handwriting. The graphical image of the handwriting is often referred to as “ink.” By using recognition software (also known as a “recognizer”), the ink may then be converted to ASCII, Unicode or other text data values.

Handwriting recognizers sometimes incorrectly convert ink to text. Such erroneous conversions can be caused by variations in the formation of handwritten text by individual users. The typical handwriting recognition system matches the handwritten ink with previously stored information to determine the proper conversion, but the input handwritten ink may vary drastically among different users.

To improve a handwriting recognizer, it is important to understand the errors it produces. This requires large amounts of handwriting data, which data is used to construct one or more test sets to quantify error rates and/or to pinpoint specific errors. Collection of handwriting data from paid volunteers has been the standard method of obtaining the needed data. However, such data collection from paid volunteers is itself prone to errors because the data is collected in a controlled environment. Paid volunteers are aware that their handwriting data is being collected and for what purpose. This knowledge of being monitored might cause the paid volunteers to alter their handwriting. There are also differences in motivation to write neatly, time constraints, or opportunities for feedback, for example. As such, it is likely that the data collected may not accurately reflect actual handwriting data that might be produced in a real-life setting with an actual user. The handwriting data received from volunteers may also depend on the volunteers that are selected. It can be difficult to obtain a true cross-section of recognizer users. Data collection from paid volunteers is also costly and time-consuming.

There remains a need in the art for methods and systems for collecting handwriting data that accurately reflects errors that would be encountered under non-simulated circumstances.

### SUMMARY

In at least some embodiments, errors in ink recognition are saved. At some desired time, a user may initiate an error report. In response to one or more dialogs, the user selects some or all of the stored errors for inclusion in the report. A report is then created to include the selected errors and transmitted to a remote location (e.g., a web server operated by a manufacturer of the recognizer). The error report may also contain various information about each error, which information can be used for categorization and searching of errors. This information may include an ink sample, the version of the recognizer used, the recognition result for the ink sample, the user-supplied correction, etc.

### BRIEF DESCRIPTION OF THE DRAWINGS

The foregoing summary, as well as the following detailed description of illustrative embodiments, is better understood when read in conjunction with the accompanying drawings, which are included by way of example, and not by way of limitation with regard to the claimed invention.

FIG. 1A is a block diagram of an example of a computing system environment in which embodiments may be implemented.

FIGS. 1B through 1M show programming interfaces, in a general-purpose computer environment, with which one or more embodiments may be implemented.

FIG. 2 is a general overview of a “life cycle” of handwriting recognition errors.

FIG. 3A is a block diagram illustrating the process of ink creation, recognition, and correction.

FIG. 3B is a block diagram illustrating an example of a system architecture for reporting handwriting recognition errors according to at least some embodiments.

FIG. 3C is a block diagram illustrating an example of queuing of handwriting recognition errors.

FIG. 4A illustrates an example of key shortcuts provided by a TIP for access to the reporting dialog.

FIG. 4B illustrates an example of an additional menu for launching a reporting dialog.

FIG. 4C illustrates an icon or shortcut to launch a reporting dialog.

FIG. 4D illustrates another example of launching a reporting dialog.

FIG. 5 is a diagram illustrating an example of an application window associated with a report generation dialog according to at least some embodiments.

FIG. 6 shows selection of errors in the window of FIG. 5.

FIG. 7 shows a dialog for verifying that error corrections, previously selected for inclusion in a report, should be transmitted.

FIG. 8 shows the dialog of FIG. 7 after an error has been verified for transmission.

FIG. 9 is an example of a dialog for confirming that a report of handwriting recognition errors should be transmitted.

FIG. 10 shows a dialog for reviewing details of a handwriting recognition error report.

FIG. 11 is an example of a dialog for entering comments associated with handwriting recognition errors according to at least some embodiments.

FIG. 12 is an example of a progress page according to at least some additional embodiments.

FIG. 13 is an example of a follow-up page according to at least some embodiments.

FIG. 14 is an example of a dialog for confirming that a handwriting recognition error report generation dialog is to be terminated.

### DETAILED DESCRIPTION OF THE PREFERRED EMBODIMENTS

The following detailed description is divided into three parts. Part I describes an example of a computer system environment in which embodiments of the invention may be implemented. Part II describes examples of programming interfaces which can be used to implement embodiments of the invention. Part III describes embodiments of handwriting recognition error collection and reporting.

### I. Example Computing System Environment

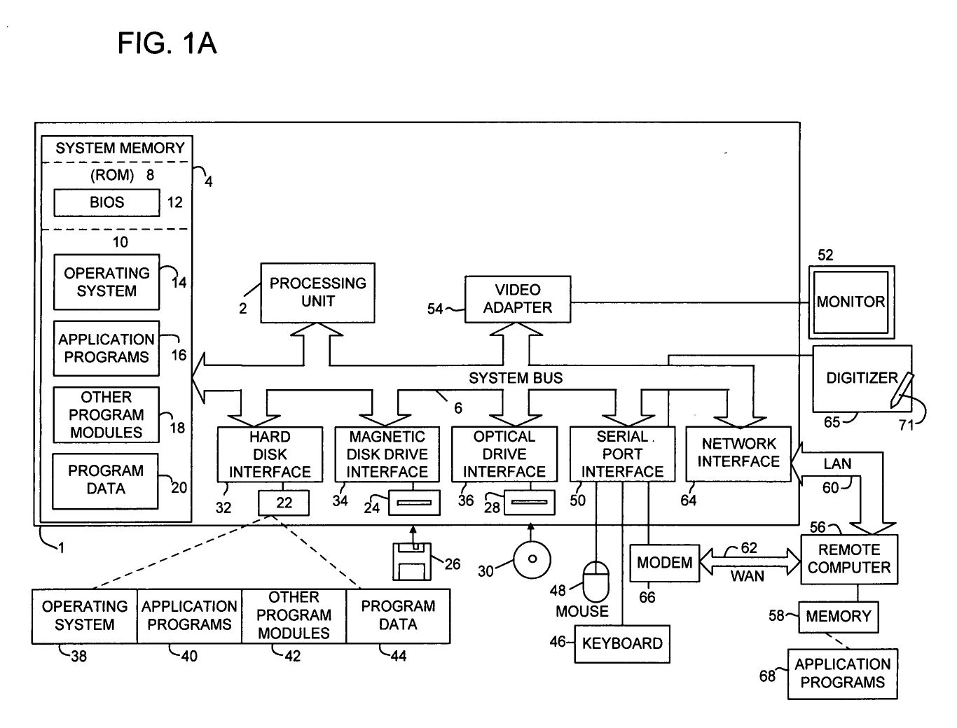

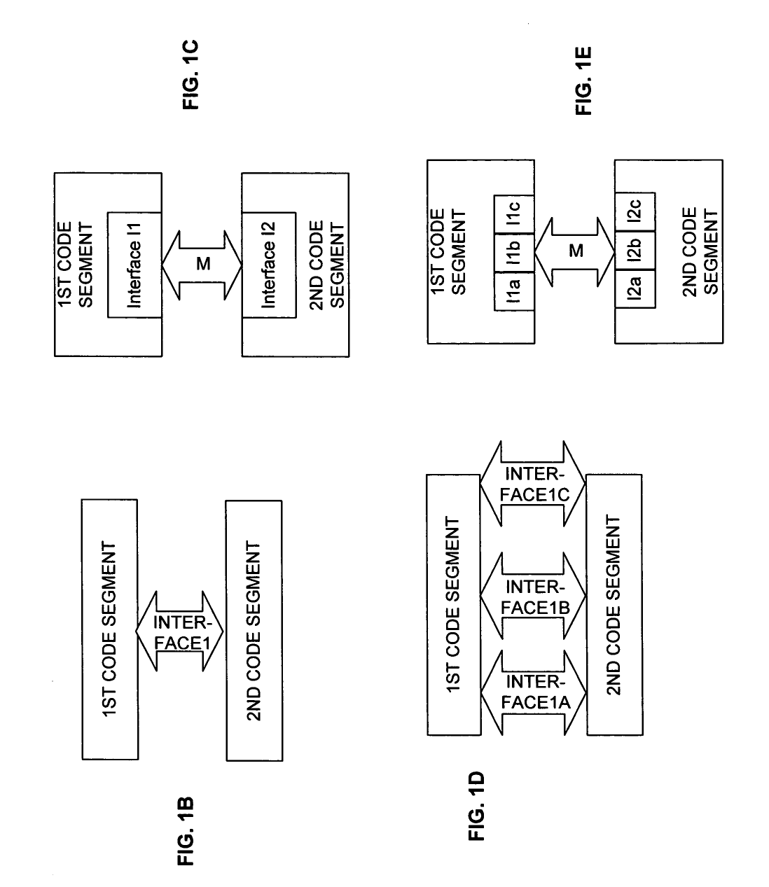

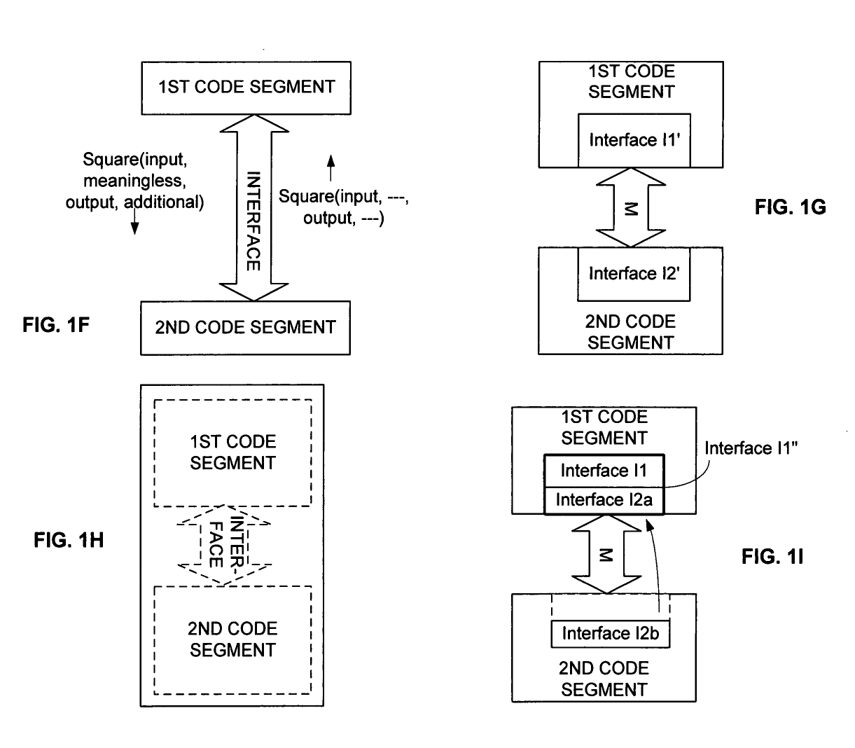

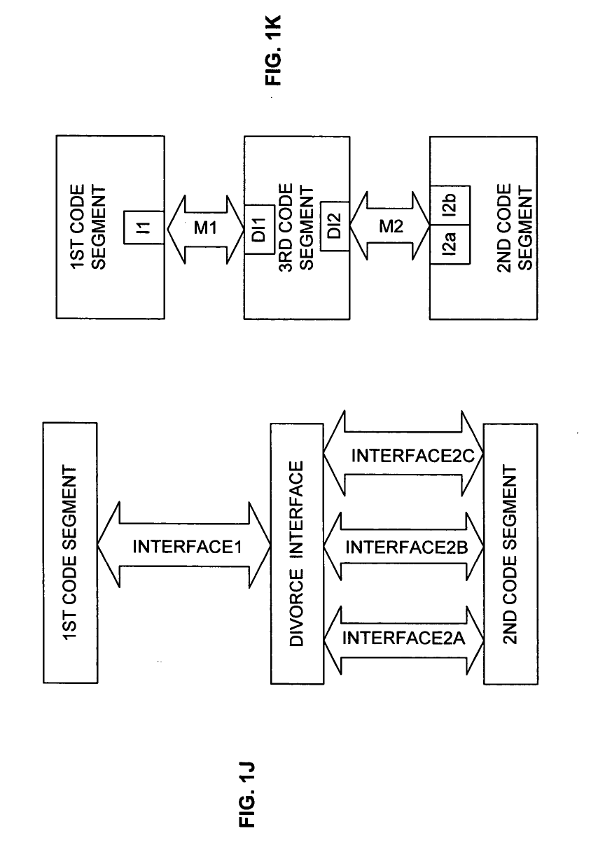

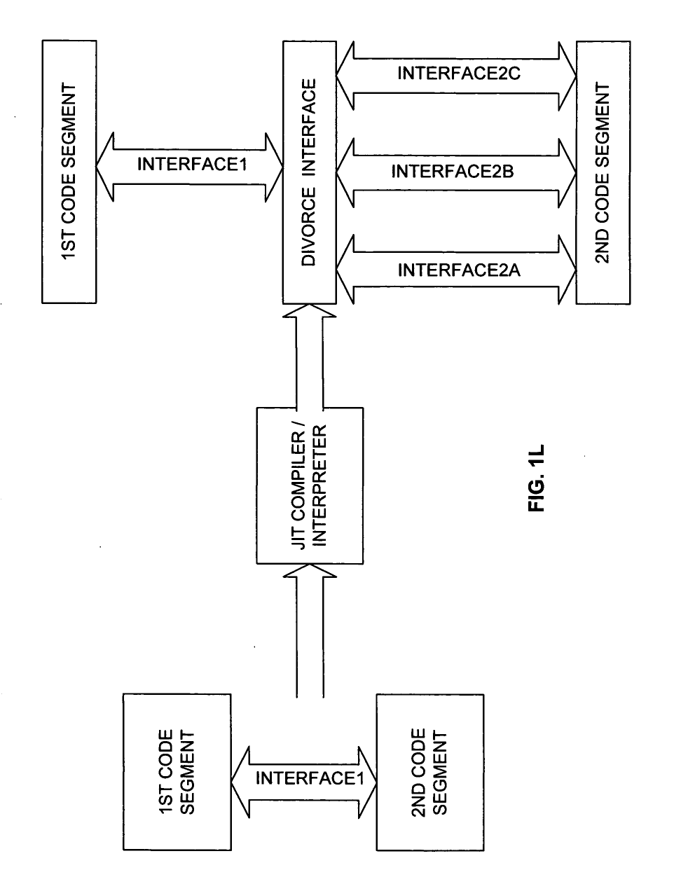

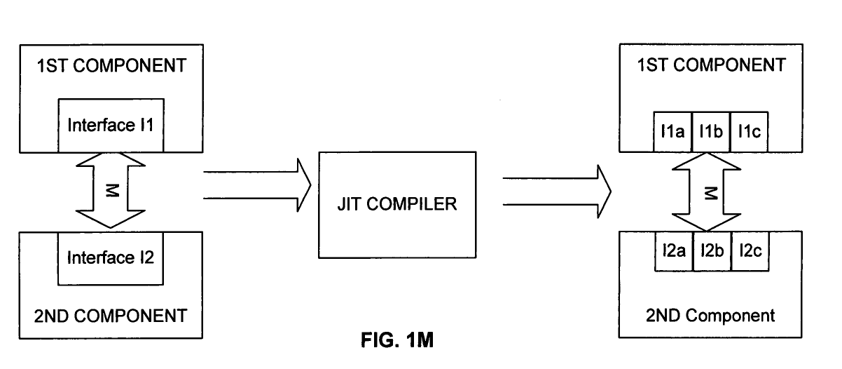

FIG. 1A illustrates an example of a suitable computing system environment in which the invention may be implemented. The computing system environment is only one example of a suitable computing environment and is not intended to suggest any limitation as to the scope of use or functionality of the invention. Neither should the computing environment of FIG. 1A be interpreted as having any dependency or requirement relating to any one or combination of components illustrated in the exemplary computing environment. Embodiments of the invention will also be described using as examples data structures found in various versions of the WINDOWS operating system. However, the invention is not limited to implementation in connection with a specific operating system.

The invention is operational with numerous other general purpose or special purpose computing system environments or configurations. Examples of well known computing systems, environments and/or configurations that may be suitable for use with the invention include, but are not limited to, personal computers, hand-held or laptop devices, multiprocessor systems, microprocessor-based systems, minicomputers, and the like. The invention is described in the general context of computer-executable instructions, such as program modules, being executed by a computer. Generally, program modules include routines, objects, components, data structures, etc. that perform particular tasks or implement particular abstract data types.

With reference to FIG. 1A, an exemplary system for implementing the invention includes a general purpose computing device in the form of a computer 1. Hardware components of computer 1 may include, but are not limited to, processing unit 2, system memory 4 and system bus 6 that couples various system components (including system memory 4 to processing unit 2. System bus 6 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus and Peripheral Component Interconnect (PCI) bus also known as Mezzanine bus.

Computer 1 typically includes a variety of computer readable media. Computer readable media can be any available media that can be accessed by computer 1 and includes both volatile and nonvolatile media, removable and non-removable media. By way of example, and not limitation, computer readable media may include computer storage media and communication media. Computer storage media includes volatile and nonvolatile, and removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infriared and other wireless media. Combinations of the any of the above should also be included within the scope of computer readable media.

System memory 4 includes computer storage media in the form of volatile and/or nonvolatile memory such as read only memory (ROM) 8 and random access memory (RAM) 10. Basic input/output system 12 (BIOS), containing the basic routines that help to transfer information between elements within computer 1, such as during start-up, is typically stored in ROM 8. RAM 10 typically contains data and/or program modules that are immediately accessible to and/or presently being operated on by processing unit 2. By way of example, and not limitation, FIG. 1A illustrates operating system (OS) 14, application programs 16, other program modules 18 and program data 20.

Computer 1 may also include other removable/non-removable, volatile/nonvolatile computer storage media. By way of example only, FIG. 1A illustrates hard disk drive 22 that reads from or writes to non-removable, nonvolatile magnetic media, magnetic disk drive 24 that reads from or writes to removable, nonvolatile magnetic disk 26 and optical disk drive 28 that reads from or writes to removable, nonvolatile optical disk 30 such as a CD ROM, CDRW, DVD or other optical media. Other removable/non-removable, volatile/nonvolatile computer storage media that can be used in the exemplary operating environment include, but are not limited to, magnetic tape cassettes, flash memory cards, digital video tape, solid state RAM, solid state ROM, and the like. Hard disk drive 22 is typically connected to system bus 6 through a non-removable memory interface such as interface 32, and magnetic disk drive 24 and optical disk drive 28 are typically connected to system bus 6 by a removable memory interface, such as interfaces 34 and 36.

The drives and their associated computer storage media, discussed above and illustrated in FIG. 1A, provide storage of computer readable instructions, data structures, program modules and other data for computer 1. In FIG. 1A, for example, hard disk drive 22 is illustrated as storing OS 38, application programs 40, other program modules 42 and program data 44. Note that these components can either be the same as or different from OS 14, application programs 16, other program modules 18 and program data 20. OS 38, application programs 40, other program modules 42 and program data 44 are given different numbers here to illustrate that, at a minimum, they are different copies. A user may enter commands and information into computer 1 through input devices such as keyboard 46, pointing device 48 (shown as a mouse, but which could be a trackball or touch pad) and stylus 71 (shown in conjunction with digitizer 65). Other input devices (not shown) may include a microphone, joystick, game pad, satellite dish, scanner, or the like. These and other input devices are often connected to processing unit 2 through user input interface 50 that is coupled to the system bus. Although mouse 48, keyboard 46, digitizer 65 and modem 66 are shown in FIG. 1A as connected to computer 1 through a serial port, these and other devices may be connected to computer 1 through other ports (e.g., a parallel port, PS/2 port, game port or a universal serial bus (USB) port) and related interfaces and structures. Monitor 52 or other type of display device is also connected to system bus 6 via an interface, such as video interface 54. In addition to the monitor, computers may also include other peripheral output devices such as speakers (not shown) and a printer (not shown), which may be connected through an output peripheral interface (not shown).

Computer 1 may operate in a networked environment using logical connections to one or more remote computers, such as remote computer 56. Remote computer 56 may be a personal computer, a server, a router, a network PC, a peer device or other common network node, and typically includes many or all of the elements described above relative to computer 1, although only memory storage device 58 has been illustrated in FIG. 1A. The logical connections depicted in FIG. 1A include local area network (LAN) 60 and wide area network (WAN) 62, but may also include other networks. Such networking environments are commonplace in offices, enterprise-wide computer networks, intranets and the Internet.

When used in a LAN networking environment, computer 1 is connected to LAN 60 through network interface or adapter 64. When used in a WAN networking environment, computer 1 may include modem 66 or other means for establishing communications over WAN 62, such as the Internet. Computer 1 may also access WAN 62 and/or the Internet via network interface 64. Modem 66, which may be internal or external, may be connected to system bus 6 via user input interface 50 or other appropriate mechanism. In a networked environment, program modules depicted relative to computer 1, or portions thereof, may be stored in the remote memory storage device. By way of example, and not limitation, FIG. 1A illustrates remote application programs 68 as residing on memory device 58. It will be appreciated that the network connections shown are exemplary and other means of establishing a communications link between computers may be used.

### II. Example Programming Interfaces

A programming interface (or more simply, interface) may be viewed as any mechanism, process or protocol for enabling one or more segment(s) of code to communicate with or access the functionality provided by one or more other segment(s) of code. Alternatively, a programming interface may be viewed as one or more mechanism(s), method(s), function call(s), module(s), object(s), etc. of a component of a system capable of communicative coupling to one or more mechanism(s), method(s), fumction call(s), module(s), etc. of other component(s). The term “segment of code” in the preceding sentence is intended to include one or more instructions or lines of code, and includes, e.g., code modules, objects, subroutines, functions, and so on, regardless of the terminology applied or whether the code segments are separately compiled, or whether the code segments are provided as source, intermediate, or object code, whether the code segments are utilized in a runtime system or process, or whether they are located on the same or different machines or distributed across multiple machines, or whether the functionality represented by the segments of code are implemented wholly in software, wholly in hardware, or a combination of hardware and software. By way of example, and not limitation, terms such as application programming (or program) interface (API), entry point, method, function, subroutine, remote procedure call, and component object model (COM) interface, are encompassed within the definition of programming interface.

A programming interface may be viewed generically as shown in FIG. lB or FIG. 1C. FIG. 1B illustrates an interface Interfacel as a conduit through which first and second code segments communicate. FIG. 1C illustrates an interface as comprising interface objects 11 and 12 (which may or may not be part of the first and second code segments), which enable first and second code segments of a system to communicate via medium M. In the view of FIG. 1C, one may consider interface objects 11 and 12 as separate interfaces of the same system and one may also consider that objects 11 and 12 plus medium M comprise the interface. Although FIGS. 1B and 1C show bidirectional flow and interfaces on each side of the flow, certain implementations may only have information flow in one direction and/or may only have an interface object on one side.

Aspects of a programming interface may include the method whereby the first code segment transmits information (where “information” is used in its broadest sense and includes data, commands, requests, etc.) to the second code segment; the method whereby the second code segment receives the information; and the structure, sequence, syntax, organization, schema, timing and content of the information. In this regard, the underlying transport medium itself may be unimportant to the operation of the interface, whether the medium be wired or wireless, or a combination of both, as long as the information is transported in the manner defined by the interface. In certain situations, information may not be passed in one or both directions in the conventional sense, as the information transfer may be either via another mechanism (e.g. information placed in a buffer, file, etc. separate from information flow between the code segments) or non-existent, as when one code segment simply accesses functionality performed by a second code segment. Any or all of these aspects may be important in a given situation, e.g., depending on whether the code segments are part of a system in a loosely coupled or tightly coupled configuration, and so this description should be considered illustrative and non-limiting.

The concept of a programming interface is known to those skilled in the art. There are various other ways to implement a programming interface. Such other ways may appear to be more sophisticated or complex than the simplistic view of FIGS. 1B and 1C, but they nonetheless perform a similar function to accomplish the same overall result. Some illustrative alternative implementations of a programming interface are described in connection with FIGS. 1D-1M.

Factoring

A communication from one code segment to another may be accomplished indirectly by breaking the communication into multiple discrete communications. This is depicted schematically in FIGS. 1D and 1E. As shown, some interfaces can be described in terms of divisible sets of functionality. Thus, the interface functionality of FIGS. 1B and 1C may be factored to achieve the same result, just as one may mathematically provide 24, or 2 times 2 times 3 times 2. Accordingly, as illustrated in FIG. 1D, the function provided by interface Interface 1 may be subdivided to convert the communications of the interface into multiple interfaces Interface1A, Interface1B, Interface1C, etc. while achieving the same result. As illustrated in FIG. 1E, the function provided by interface I1 may be subdivided into multiple interfaces I1a, I1b, I1c, etc. while achieving the same result. Similarly, interface 12 of the second code segment which receives information from the first code segment may be factored into multiple interfaces I2a,I2b, I2c, etc. When factoring, the number of interfaces included with the 1st code segment need not match the number of interfaces included with the 2nd code segment. In either of the cases of FIGS. 1D and 1E, the functional spirit of interfaces Interface 1 and I1 remain the same as with FIGS. 1B and 1C, respectively. The factoring of interfaces may also follow associative, commutative, and other mathematical properties such that the factoring may be difficult to recognize. For instance, ordering of operations may be unimportant, and consequently, a function carried out by an interface may be carried out well in advance of reaching the interface, by another piece of code or interface, or performed by a separate component of the system. Moreover, one of ordinary skill in the programming arts can appreciate that there are a variety of ways of making different function calls that achieve the same result.

Redefinition

In some cases, it may be possible to ignore, add or redefine certain aspects (e.g., parameters) of a programming interface while still accomplishing the intended result. This is illustrated in FIGS. 1F and 1G. For example, assume interface Interface1 of FIG. 1B includes a function call Square(input, precision, output), a call that includes three parameters (“input,” “precision” and “output”) and which is issued from the 1st Code Segment to the 2nd Code Segment. If the middle parameter (“precision”) is of no concern in a given scenario, as shown in FIG. 1F, it could be ignored, or replaced with another parameter. In either event, the functionality of Square can be achieved, so long as output is returned after input is squared by the second code segment. Precision may very well be a meaningful parameter to some downstream or other portion of the computing system; however, once it is recognized that precision is not necessary for the narrow purpose of calculating the square, it may be replaced or ignored. For example, instead of passing a valid precision value, a meaningless value such as a birth date could be passed without adversely affecting the result. Similarly, as shown in FIG. 1G, interface I1 is replaced by interface I1′, redefined to ignore or add parameters to the interface. Interface I2 may similarly be redefined (as interface I2′) to ignore unnecessary parameters, or parameters that may be processed elsewhere. As is clear from the foregoing, a programming interface may in some cases include aspects such as parameters which are not needed for some purpose, and which may be ignored, redefined, or processed elsewhere for other purposes.

Inline Coding

It may also be feasible to merge some or all of the functionality of two separate code modules such that the “interface” between them changes form. For example, the functionality of FIGS. 1B and 1C may be converted to the functionality of FIGS. 1H and 1I, respectively. In FIG. 1H, the previous 1st and 2nd Code Segments of FIG. 1B are merged into a module containing both of them. In this case, the code segments may still be communicating with each other but the interface may be adapted to a form which is more suitable to the single module. Thus, for example, formal Call and Return statements may no longer be necessary, but similar processing or response(s) pursuant to interface Interface1 may still be in effect. Similarly, shown in FIG. 1I, part (or all) of interface I2 from FIG. 1C may be written inline into interface I1 to form interface I1″. As illustrated, interface I2 is divided into I2a and I2b, and interface portion I2a has been coded in-line with interface I1 to form interface I1″.

Divorce

A communication from one code segment to another may be accomplished indirectly by breaking the communication into multiple discrete communications. This is depicted schematically in FIGS. 1J and 1K. As shown in FIG. 1J, one or more piece(s) of middleware (Divorce Interface(s), since they divorce functionality and/or interface functions from the original interface) are provided to convert the communications on the first interface, Interface1, to conform them to a different interface, in this case interfaces Interface2A, Interface2B and Interface2C. This might be done, e.g., where there is an installed base of applications designed to communicate with, say, an operating system in accordance with an Interface1 protocol, but then the operating system is changed to use a different interface, in this case interfaces Interface2A, Interface2B and Interface2C. The point is that the original interface used by the 2nd Code Segment is changed such that it is no longer compatible with the interface used by the 1st Code Segment, and so an intermediary is used to make the old and new interfaces compatible. Similarly, as shown in FIG. 1K, a third code segment can be introduced with divorce interface DI1 to receive the communications from interface I1 and with divorce interface DI2 to transmit the interface functionality to, for example, interfaces I2a and I2b, redesigned to work with DI2, but to provide the same functional result. Similarly, DI1 and DI2 may work together to translate the functionality of interfaces I1 and I2 of FIG. 1C to a new operating system, while providing the same or similar fimctional result.

Rewriting

Yet another possible variant is to dynamically rewrite code to replace the interface functionality with something else but which achieves the same overall result. For example, there may be a system in which a code segment presented in an intermediate language (e.g. Microsoft IL, Java ByteCode, etc.) is provided to a Just-in-Time (JIT) compiler or interpreter in an execution environment (such as that provided by the Net framework, the Java runtime environment, or other similar runtime type environments). The JIT compiler may be written so as to dynamically convert the communications from the 1st Code Segment to the 2nd Code Segment, i.e., to conform them to a different interface as may be required by the 2nd Code Segment (either the original or a different 2nd Code Segment). This is depicted in FIGS. 1L and 1M. As can be seen in FIG. 1L, this approach is similar to the Divorce scenario described above. It might be done, e.g., where an installed base of applications are designed to communicate with an operating system in accordance with an Interface1 protocol, but then the operating system is changed to use a different interface. The JIT Compiler could be used to conform the communications on the fly from the installed-base applications to the new interface of the operating system. As depicted in FIG. 1M, this approach of dynamically rewriting the interface(s) may be applied to dynamically factor, or otherwise alter the interface(s) as well.

It is also noted that the above-described scenarios for achieving the same or similar result as an interface via alternative embodiments may also be combined in various ways, serially and/or in parallel, or with other intervening code. Thus, the alternative embodiments presented above are not mutually exclusive and may be mixed, matched and combined to produce the same or equivalent scenarios to the generic scenarios presented in FIGS. 1B and 1C. It is also noted that, as with most programming constructs, there are other similar ways of achieving the same or similar functionality of an interface which may not be described herein, but nonetheless are represented by the spirit and scope of the invention.

### II. Handwriting Recognidon Error Collecdon and Reporting

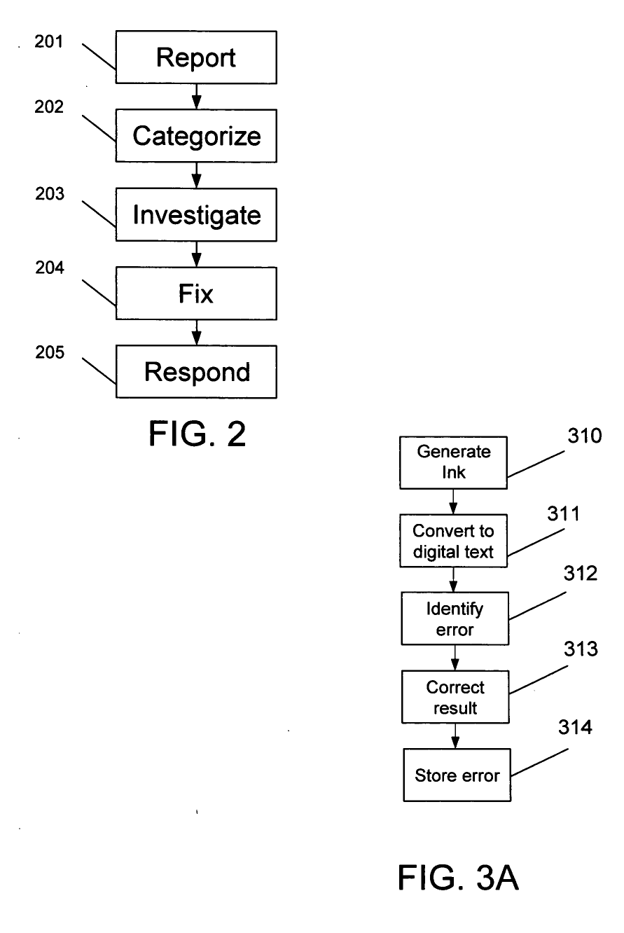

Shown in FIG. 2 is a general overview of a “life cycle” of handwriting recognition errors, including a report step 201, a categorize step 202, an investigate step 203, a fix step 204, and a respond step 205.

In the report step 201 handwriting recognition errors to be reported may be identified. For example, a user may have identified handwriting recognition errors and corrected them. After correction of these errors, the errors and their corrections may be stored, for example, as a list on a hard drive or other non-volatile memory. Alternatively, errors and corrections may only be stored in volatile memory (RAM) for increased security. During the report step 201, the list of stored handwriting recognition errors may be displayed so that the user may select handwriting recognition errors from the list to report to a developer (e.g., by selection of desired errors from a list of all errors).

In the categorize step 202, handwriting recognition errors may be categorized based on particular features described by bucketing parameters which may be stored with the handwriting recognition error itself. For example, one parameter may correspond to a particular unrecognized text string. Recognition errors sharing a similar parameter value may later be grouped into categories or “buckets.” In this manner, later analysis of errors is more efficient. In at least some embodiments, categorization of errors (e.g., associating parameter values with a corrected error) may occur as each error correction is added to the previously mentioned error correction list.

After handwriting recognition errors are stored and selected for transmission, the selected handwriting recognition errors may be included in a handwriting recognition error report which is transmitted to a developer. In the investigate step 203, a developer may receive the handwriting recognition error report and examine the errors. This may include, for example, requesting additional information from the user. Based on the investigation, the developer may discover a means for fixing the error and preventing the error from re-occurring.

In the Fix step 204, the error is corrected. For example, this may entail the creation of additional code to correct the problem and may entail pushing a patch to users.

In the Respond step 205, the user is provided with a report of the problem and/or with information necessary to resolve the issue.

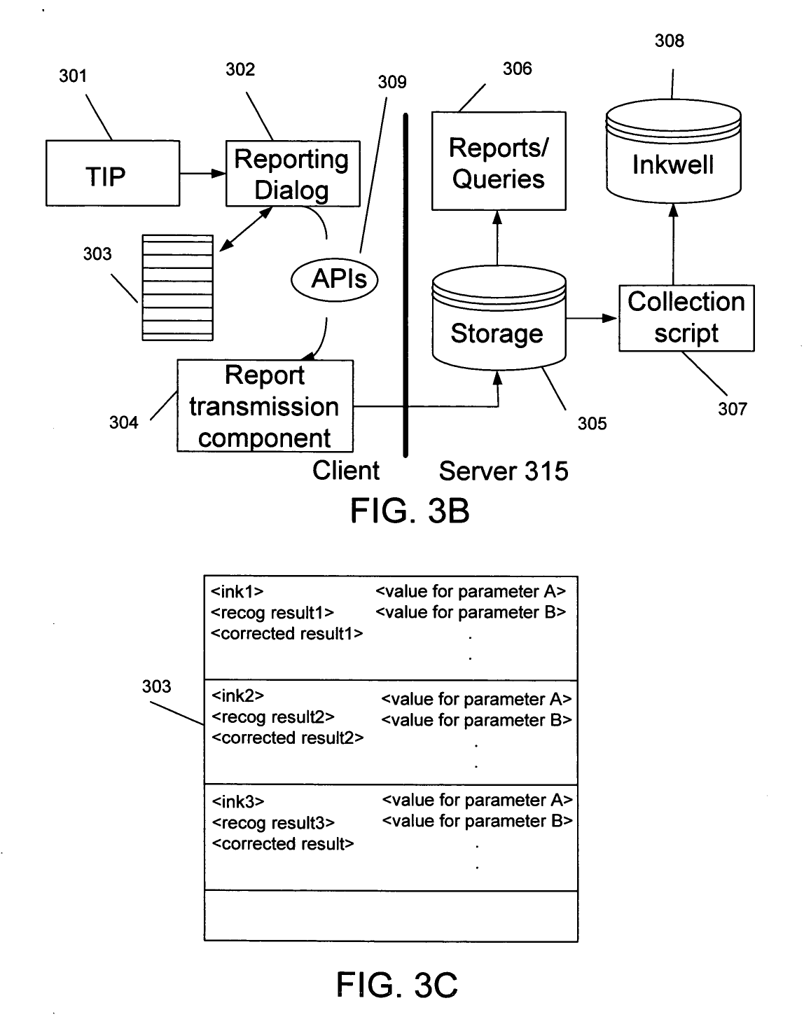

FIG. 3A is a block diagram of a process by which handwriting ink is generated, recognized and corrected. The user generates the ink in step 310. This may include a user inputting handwritten text into a computer system. For example, a user may enter handwritten text using a stylus on a tablet PC. In step 311, the input ink is converted to digital text by a recognizer that analyzes the ink and converts the ink into Unicode, ASCII or other type of text data. In step 312, the user is dissatisfied with the recognition result. In Step 313, the user corrects the result (by, e.g., inputting the desired recognition result). In step 314, the handwriting recognition error is added to a storage with other handwriting recognition errors, if any. The error may be stored, for example, with the original ink sample, the text as recognized by the recognizer, and/or the corrected text. Also, bucketing parameters may be stored with the error. As set forth above, each bucketing parameter may correspond to a particular characteristic of the handwriting recognition error. Based on the combination of bucketing parameters, handwriting recognition errors may later be grouped in buckets with other similarly created errors. In this way, investigation and correction of the error is facilitated.

FIG. 3B is a block diagram illustrating an example of a system architecture for reporting handwriting recognition errors. Shown in FIG. 3B is the Tablet PC Input Panel (TIP) 301. The TIP 301 is a region displayed on a computer screen which allows a user to enter text or error correction commands. As explained in more detail below, the TIP 301 also permits a user to launch a reporting user interface (UI). The reporting UI may be at least one reporting dialog 302 as illustrated generically in the example of FIG. 3B, although the present invention is not so limited. The reporting dialog 302 guides a user through the process of reporting and/or categorizing handwriting recognition errors and generating, queuing and transmitting an error report. In addition, the reporting dialog 302 may also access a queue 303 which stores previous recognition errors. For example, after a user inputs ink, a recognizer may convert the input ink to digital text (see FIG. 3A). If there is a handwriting recognition error, the user may correct the error, for example, by entering the correct text. Each such error, or a specified number of errors (e.g., the last 50 errors) may be stored in the queue 303.

Prior to user selection of handwriting recognition errors to be included in a handwriting recognition error report, a reporting dialog 302 obtains a list of all handwriting recognition errors by accessing the queue 303, and displays the list of errors to the user. After the user selects desired handwriting recognition errors for reporting from the displayed list of handwriting recognition errors, the reporting dialog 302 generates the report. Via calls to application program interfaces (APIs) 309, the reporting dialog 302 provides the generated handwriting recognition error report to the report transmission component 304. Component 304 then asynchronously transmits the report to the server 315. In an alternate example, the reporting dialog 302 may pass information associated with the selected handwriting recognition errors, via APIs 309, to component 304, with component 304 generating and transmitting the report.

FIG. 3C illustrates the queue 303 of FIG. 3B. As set forth above, handwriting recognition errors may be stored in the queue 303 as they are identified and corrected by the user. The errors may be stored, for example, in the queue 303 with the input handwriting (i.e., ink), the corresponding digital text as recognized by the system, and the corrected result. In FIG. 3C, the ink, recognized result, and corrected result of each handwriting recognition error are represented generically in brackets. The stored errors may also include parameters categorizing handwriting recognition errors, which parameters may later be used (e.g., after receipt by server 315 and placed in storage 305) for “bucketing” the errors. Values for the bucketing parameters are represented generically in brackets in FIG. 3C. There are many types of bucketing parameters that may be used to categorize handwriting recognition errors. For example, the handwriting recognition errors may be categorized based on original text.

After a handwriting recognition error report is generated, the error report may be transmitted to a server. For additional security, the error report may be transmitted over an SSL connection. After receipt at the server, the error data may be analyzed and a solution obtained (the investigate step 203 and in the fix step 204, FIG. 2). A storage 305 is provided at the server and may be a SQL database. The error data stored in storage 305 may be accessed through queries or reports 306 as illustrated in FIG. 3B. If each of the handwriting recognition errors stored in storage 305 have been assigned values for various categorization parameters, query of the storage 305 for desired handwriting recognition errors within a category (or “bucket”) is simplified. As one non-limiting example, a query 306 may be made to the storage 305 to return all handwriting recognition errors, occurring for left-handed users of a specific version of a recognizer or a specific operating system, and in which a particular word was recognized as another particular word. Additional examples of categorization parameters and values thereof are provided below.

Additionally, data may be further retained in an internal database such that further manipulation of the data may be performed without corruption of the original data. For example, handwriting recognition errors in a particular bucket may be retrieved from storage 305 and moved to internal database 308 (“inkwell”) for further analysis. In this example, a collection script 307 may access the storage 305 to collect desired handwriting recognition errors. The collection script 307 may be a software component, for example, for accessing, locating and retrieving handwriting recognition errors.

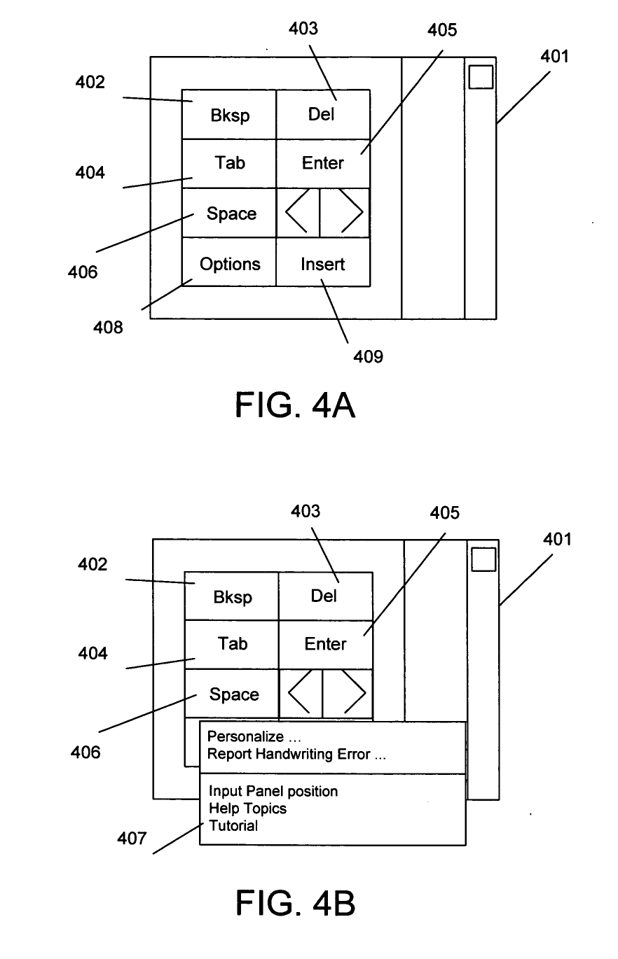

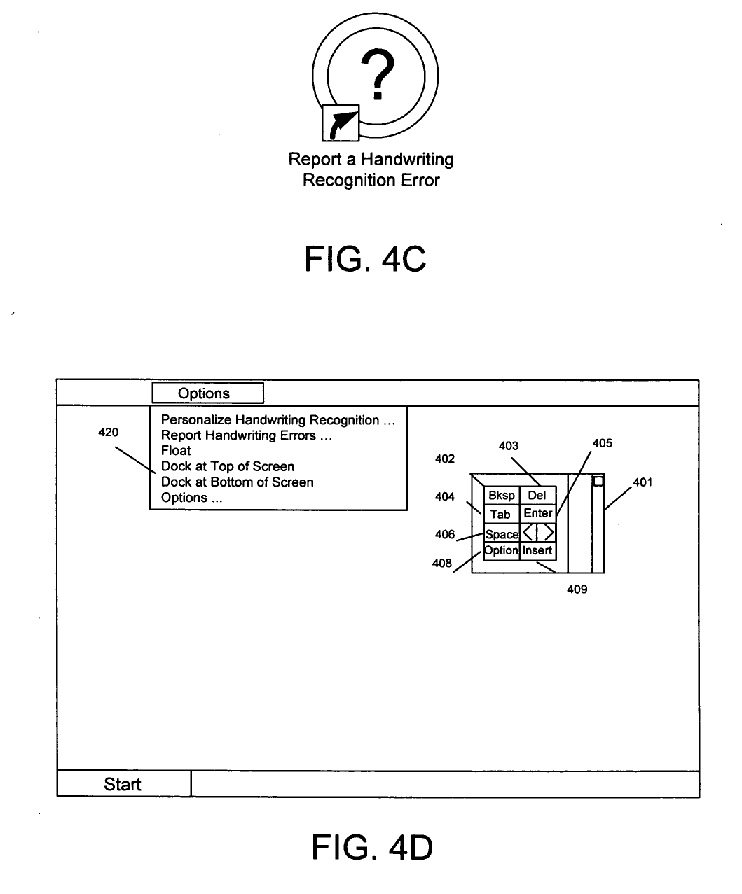

The reporting dialog 302 in this example is accessed through the TIP 301 (FIG. 3B). For example, the TIP 301 may provide a user with a menu option for launching the reporting dialog 302. FIG. 4A illustrates an example of a menu provided by the TIP 301 for access to the reporting dialog 302. In this example, the TIP 301 provides text input tools on a tool menu 401. The tool menu 401 may contain a plurality of tools for text input as illustrated in FIG. 4A. These tools may be in the form of virtual keys, i.e., areas on the menu which a user can select with a stylus (e.g., the stylus 71 in FIG. 1A). For example, the tool menu 401 may contain a backspace key 402, a delete key 403, a tab key 404, an enter key 405, an insert key 409, and a space key 406. Additionally, the tool menu 401 may also contain an element for displaying another menu, such as an options menu 407. FIG. 4A illustrates only some examples of tools or function keys, and the tool menu 401 may contain other keys.

FIG. 4B illustrates an example of the display of a menu 407 responsive to selecting the options key 408 in FIG. 4A. A selection of a corresponding menu item on the menu 407 may invoke the reporting dialog 302. As FIG. 4B illustrates, menu 407 contains a menu item (e.g., “Report Handwriting Recognition Errors . . . ”) to launch the reporting dialog 302 for reporting a handwriting error. By selecting the menu item (e.g., “Report Handwriting Error . . . ”), the reporting dialog 302 may be launched and a reporting dialog application window opened as the top-most window on the display. Also, the TIP 301 may be closed when the reporting wizard application window opens to provide additional space on the display for the reporting wizard application window.

There are many other ways in which the reporting dialog 302 may be launched. For example, a shortcut or item may be provided in a start menu. When the shortcut or item in the start menu is selected, the reporting dialog 302 may be launched and a handwriting recognition error report may be generated and transmitted. Alternatively, a shortcut (having an icon) placed on the desktop may be used to launch the reporting dialog 302. FIG. 4C illustrates an icon on a desktop for launching the reporting dialog 302. If a user selects the icon, the reporting dialog 302 is launched.

FIG. 4D illustrates another example of displaying an options menu for reporting of handwriting errors. In this example, the TIP 401 is displayed on the display, however the options menu 420 containing a selection for reporting handwriting errors is on a separate button and is not related to the panel of key shortcuts of the TIP 401. For example, as illustrated in FIG. 4D, the option menu 420 may be associated with a button on a start menu. Selection of the “handwriting error report” option results in launching a dialog for selection of handwriting recognition errors to report as described herein.

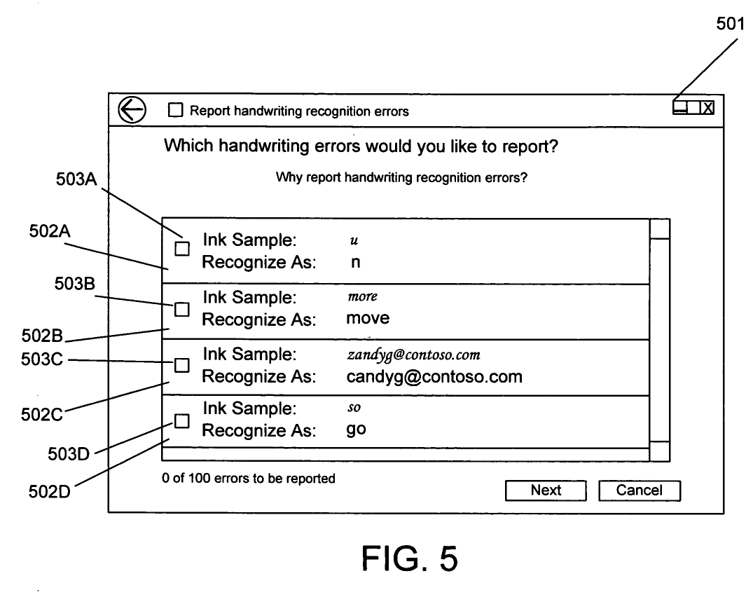

FIG. 5 illustrates an example of an application window associated with the reporting dialog 302. In this example, the application window 501 provides a list of words or characters which were previously corrected and stored in queue 303 (see FIG. 3B or 3C). These handwriting recognition errors may be displayed as items on a display as illustrated as 502A-502D in FIG. 5. These handwriting recognition errors as displayed (502A-502D) may potentially be included in an error report. As to the first error (502A) shown in FIG. 5, a user previously inked the letter “u” (step 310 of FIG. 3A), and the system converted the handwritten letter “u” to a digital “n” (step 311 of FIG. 3A). A handwriting recognition error was identified (step 312 of FIG. 3A) and the digital “n” was corrected to the letter “u” (step 313 of FIG. 3A). This error was then stored (step 314 of FIG. 3A). The error stored includes the ink sample (i.e., the handwritten letter “u”) and the recognized text (i.e., the letter “n”) as well as the corrected text (i.e., the letter “u”).

As to the second error (502B) shown in FIG. 5, a user previously inked the word “more” (step 310 of FIG. 3A), and the system converted the handwritten word “more” to a digital word “move” (step 311 of FIG. 3A). A handwriting recognition error was identified (step 312 of FIG. 3A) and the digital word “move” was corrected to the word “more” (step 313 of FIG. 3A). This error was then stored (step 314 of FIG. 3A). The error stored includes the ink sample (i.e., the handwritten word “more”) and the recognized text (i.e., the word “move”) as well as the corrected text (i.e., the word “more”).

As to the third error (502C) shown in FIG. 5, a user previously inked the string “zandyg@contoso.com” (step 310 of FIG. 3A), and the system converted the string to a digital string “candyg@contoso.com” (step 311 of FIG. 3A). A handwriting recognition error was identified (step 312 of FIG. 3A) and the digital string “candyg@contoso.com” was corrected to the string “zandyg@contoso.com” (step 313 of FIG. 3A). This error was then stored (step 314 of FIG. 3A). The error stored includes the ink sample (i.e., the handwritten string “zandyg@contoso.com”) and the recognized text (i.e., the string “candyg@contoso.com”) as well as the corrected text (i.e., the string “zandygcontoso.com”).

As to the fourth error (502D) shown in FIG. 5, a user previously inked the word “so” (step 310 of FIG. 3A), and the system converted the handwritten word “so” to a digital word “go” (step 311 of FIG. 3A). A handwriting recognition error was identified (step 312 of FIG. 3A) and the digital word “go” was corrected to the word “so” (step 313 of FIG. 3A). This error was then stored (step 314 of FIG. 3A). The error stored includes the ink sample (i.e., the handwritten word “so”) and the recognized text (i.e., the word “go”) as well as the corrected text (i.e., the word “so”).

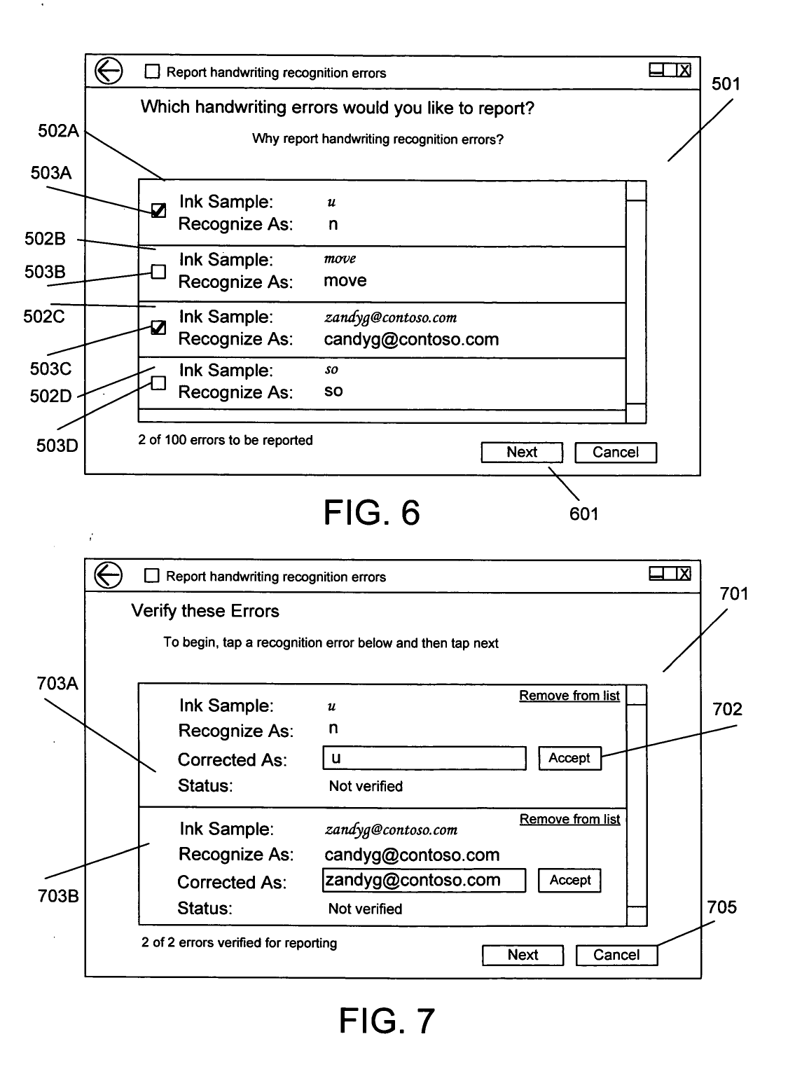

In FIG. 6, some of the errors in the application window 501 have been selected for reporting. Any of the handwriting recognition errors 502A-502D can be selected to be reported. In this example, a check box (503A-503D) is associated with each item in the list of handwriting recognition errors (502A-502D, respectively). A user may check the box associated with desired items on the list to select them. As FIG. 6 illustrates, handwriting recognition errors 502A and 502C are selected through corresponding check boxes (i.e., 503A and 503C, respectively). The handwriting recognition error in which the recognizer misinterpreted a handwritten letter “u” with the letter “n” is selected, as well as the handwriting recognition error in which the recognizer misinterpreted the e-mail address “zandyg@contoso.com” with “candyg@contoso.com.” By checking a box, the corresponding handwriting recognition error is marked for inclusion in an error report. Also, a counter may be maintained to indicate the number of ink samples added to the list. For each check box that is selected, the counter increases by 1. After the desired selections are made, the “Next” button 601 may be selected to advance to another window.

FIG. 7 shows a subsequent dialog window 701. In window 701, the user is provided an opportunity to verify that the errors selected for inclusion (FIG. 6) should indeed by transmitted in an error report. In this example, the two handwriting recognition errors selected for reporting are shown as fields 703A and 703B in window 701. A status of the handwriting recognition error is also indicated. In the example of FIG. 7, a selected handwriting recognition error is “verified” after the user “accepts” the handwriting recognition error by selecting a dialog control element 702. In this example, the dialog control element 702 selected by the user is an “accept” button to indicate that the handwriting recognition error is accepted to be placed in the error report to be transmitted. A status of “Not verified” indicates the user has not yet confirmed that the handwriting recognition error is to be included in the error report.

The user may further change the corrected word or character. For example, if the user desires further changes to the recognition result, the word or character displayed in the “corrected as:” field may be edited. Thus, for the first handwriting recognition error displayed, if the user discovers that the ink sample was not “u”, the user may change the letter in the “corrected as” field to reflect the correct letter or character.

If the user determines that the handwriting recognition error should not be reported or was initially selected in error, the user may remove the handwriting recognition error from the list. For example, the user may select a control element such as a button or menu item to remove the error. In addition, if a counter to provide the number of errors on the list of handwriting recognition errors to be verified is used, the counter may be decremented by the appropriate number. Alternatively, the user may remove handwriting recognition errors from the list by returning to a previous page so that entry and selection of handwriting recognition errors begins anew.

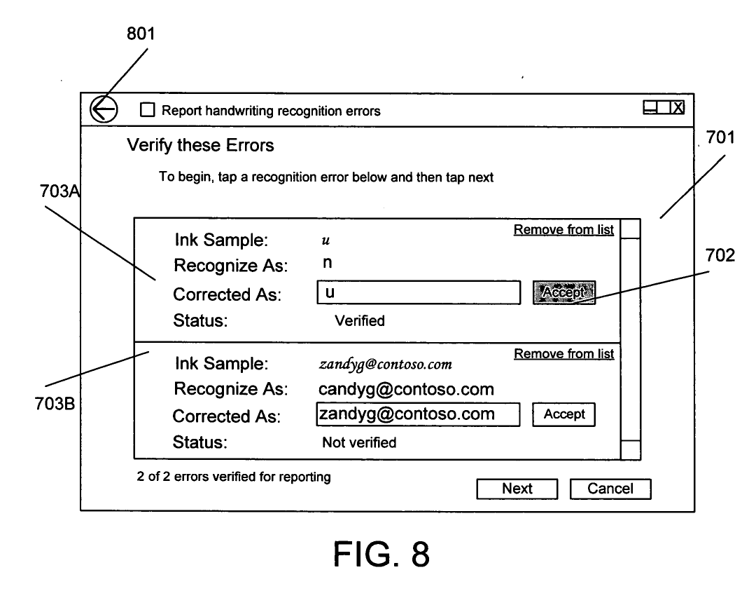

FIG. 8 illustrates the verify errors window of the reporting wizard in which one of the selected handwriting recognition errors has been verified The user dialog control element (the “Accept” button 702 in this example) is removed or disabled after verification. If the user wishes to remove an accepted handwriting recognition error from the list, the user may manually go back to the previous page by selecting the back button 801 to redo the selections. Alternatively, a dialog control element such as a button to “un-accept” the handwriting recognition error (not shown) may also be provided.

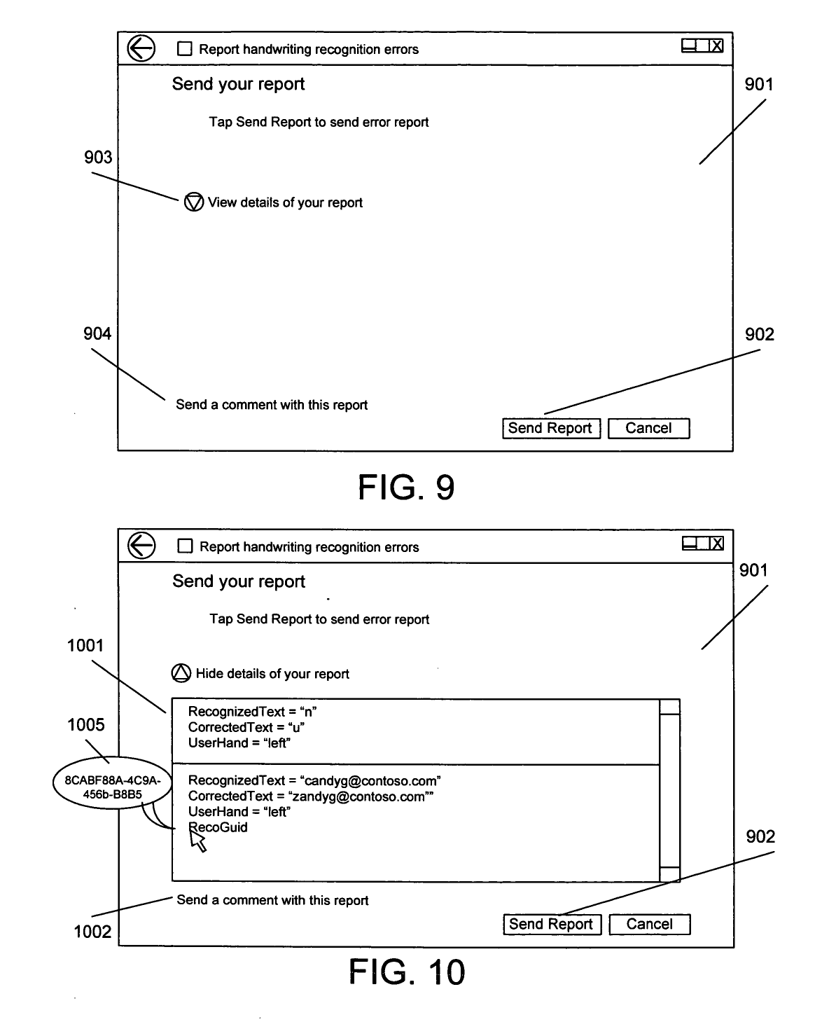

FIG. 9 shows a subsequent page of the dialog in which the confirmation window 901 may instruct the user to click a button to send the report. The user may also request further details of the report. For example, a user dialog control element 903 may be provided in the confirmation window 901 to provide a list of handwriting recognition errors to be transmitted. The list may be invoked by the user by selection of the user dialog control element 903. The user dialog control element 903 may be any element for input of a selection. Non-limiting examples of a user dialog control element 903 include a button, an icon, etc.

FIG. 10 illustrates an example of an expanded detailed report 1001 of the handwriting recognition errors. In this example, a report window 1001 appears within the confirmation window 901 responsive to a selection of a user dialog control element 903 and may provide any desired or pertinent information of the report. For example, the ink sample, bucketing parameters and values, additional XML file parameters or an ink comment may be shown in the report window 1001. Parameter values may be displayed as raw, un-localized text, i.e., text that is displayed as the text string that is actually transmitted rather than text that is converted to text strings that are localized for particular users. Also, each parameter value may be associated with a tooltip to show the full text such that additional information for a parameter may be viewed by, for example, a pop-up tooltip that appears responsive to hovering a cursor over the parameter. In the example illustrated in FIG. 10, the value for the RecoGUID parameter is displayed as a tooltip 1005 when a cursor is hovered over the parameter displayed on the display. Table I provides examples of names of parameters and corresponding values that may be included in the report window 1001. Each row in Table I provides the name, definition and a sample value for a different parameter. The sample values in Table I are indicated with quotation marks for clarity. However, quotation marks may also be excluded.

TABLE I

| Parameter | Definition | Sample Value(s) |
|---|---|---|
| RecoGuid | Recognizer GUID (global unique | “8CABF88A-4C9A-456b-B8B5- |
| | identifier) (a unique number | 14A0DF4F062B” |
| | assigned to a TabletPC to identify | |
| | the particular recognizer) | |
| RecoVersion | Recognizer Version - identifies | “1.0.1038.0” |
| | the version | “1.7.2600.2180” |
| | | “1.0.2201.0” |
| RecoVendor | Recognizer Vendor - identifies the | Microsoft Corporation |
| | vendor | “Joe's House of Handwriting” |
| TipSkin | Input Panel Skin - (e.g., indicating | “lined” |
| | if the TIP is in lined mode (input | “boxed” |
| | entire words) or in boxed mode | |
| | (input individual characters) | |
| InputScope | Input Scope (e.g., indicating a | “(!IS_DEFAULT)” |
| | specific type of possible input such | “(!IS_DIGITS\|a\|b\|c))” |
| | as text or digits and which may be | “(0\|1\|2\|3\|4\|5\|7\|8\|9\|0\|A\|B\|C\|D\|E\|F)+” |
| | used to provide relevant, | |
| | application-specific information to | |
| | the recognizer to improve | |
| | recognition accuracy) | |
| RecognizedText | Recognized Text | “yon” |
| | | “Yon” |
| | | “http://www.gaggle.com” |
| | | “I” |
| CorrectedText | Corrected Text | “you” |
| | | “You” |
| | | “http://www.goggle.com” |
| | | “1” |
| OSVersion | OS Version | “5.1.2600” |
| | | “6.0.1234” |
| OSServicePack | OS Software modules | “Service Pack 3” |
| InputLcid | Input LCID - specifies operating | “3082” |
| | system settings based on | “1034” |
| | geographical location (country/ | |
| | region). | |
| UserHand | User Hand - indicates which hand | “left” |
| | the user uses to write (e.g., right- | “right” |
| | handed or left-handed) | |
| PhraseListCount | Phrase List Count - indicates the | “” |
| | number of phrases processed | “36” |
| | | “13209” |
| | | “0” |
| IsStringSupported | Is string found in Dictionary | “true” |
| | | “false” |
| PersonalizationsData | Personalization Data | GUID=“92A7CF3A-4323-41d0- |
| | | B9A9-02D00D6C4452” FileLength |
| | | = “32103” |
| | | GUID= “CC16FB8A-3291-49a2- |
| | | 9B82-F54F9AD54A489” |
| | | FileLength=”12” |
| | | GUID-“23C9294F-98E8-40dd- |
| | | 8AED- |
| | | 4EEB535BB357”Filelength=”1067” |
| Comment | Comment | “This error is annoying!” |

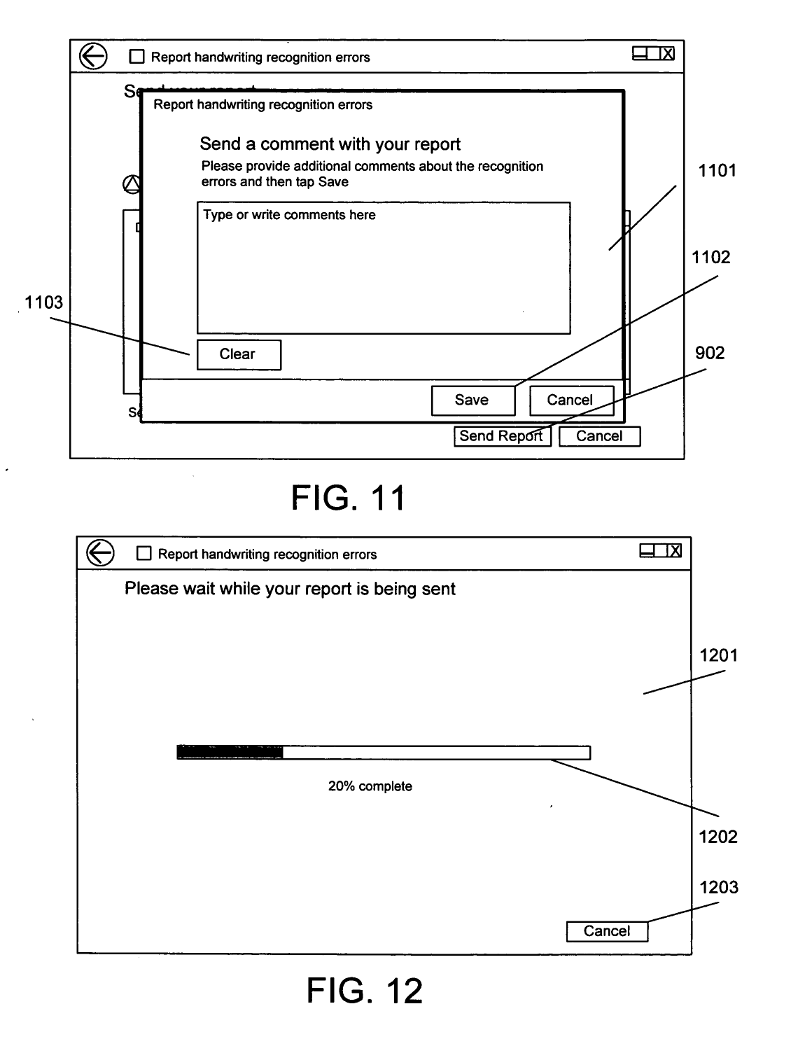

In at least some embodiments, and as illustrated in FIGS. 9 and 10, a user may also send a comment with an error report. If the user wishes to provide additional comments or questions when sending the report, the user may select a user dialog control element 904 or 1002 to invoke a comment window or dialog. The dialog window may be modal or non-modal. Any control element may be used as the user dialog control element 904 or 1002, for example, a button or menu item. FIG. 11 illustrates one example of a dialog 1101. A user may enter comments into the dialog 1101 and save the comment by selecting a corresponding user dialog control element such as the “Save” button 1102. Alternatively, the user may select a user dialog control element such as a “Clear” button 1103 to purge the contents of the dialog 1101. When the “Save” button 1102 is selected, the comment is saved.

If the user selects the “Send Report” button 902 in the example illustrated in FIG. 9, a progress page may appear. FIG. 12 illustrates an example of a progress page 1201. The progress page 1201 may contain a progress indicator 1202 indicating the progress of transmission of the error report as the error report is being transmitted. In one embodiment, the error report is transmitted to the OS developer. In an alternate embodiment, the error report may be transmitted to a separate developer of the recognizer. After transmission, the developer may further process the error data. For example, the developer may investigate the error to determine the cause and may further create a fix to correct the error and to prevent the error from re-occurring. In some cases, the error report may not immediately be transmitted and instead may be placed temporarily in a reporting queue. For example, the connection may be unavailable to the developer or the website may be down or busy. If receipt of the error report by the intended recipient cannot be confirmed at the time of generation and transmission, each error report is added to a transmission queue.

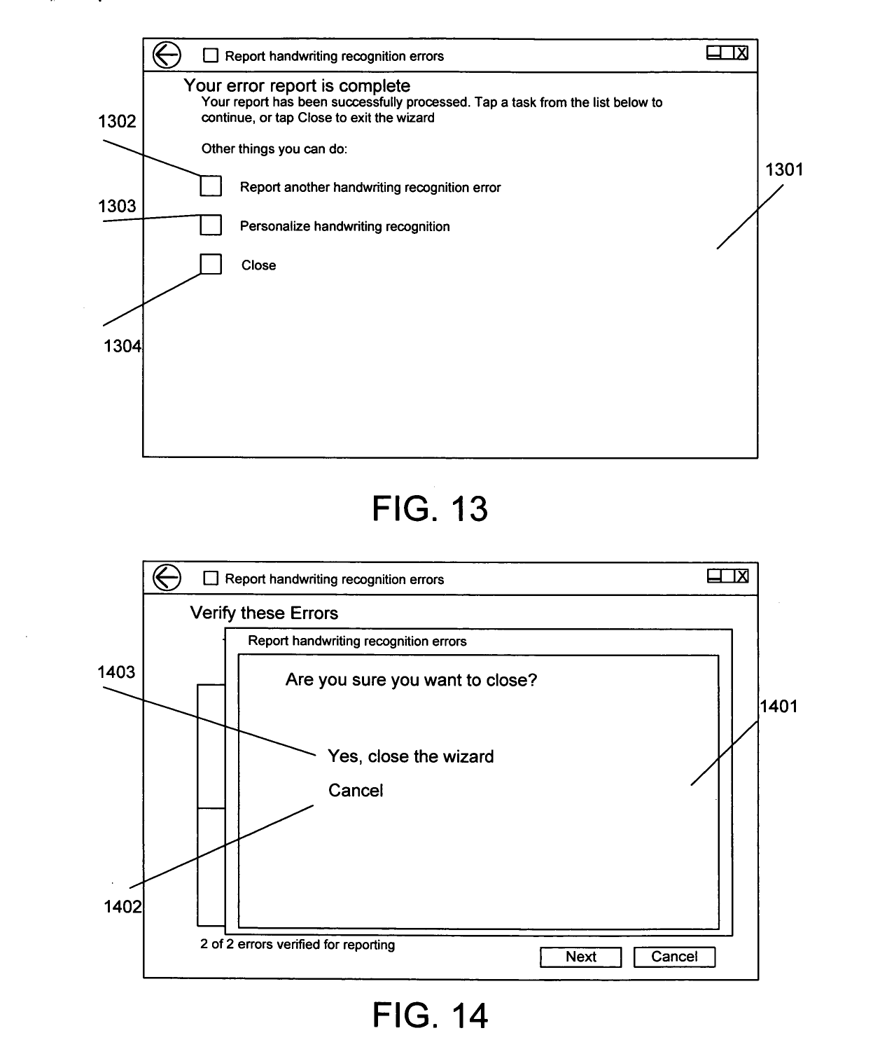

After the error report is successfuilly transmitted (or, alternatively, successfully queued in the transmission queue as set forth above), a follow-up page may be provided. FIG. 13 illustrates an example of a follow-up page 1301. In this example, a user may select a user dialog control element 1302 to create another error report. If the user selects the user dialog control element 1302 to report a handwriting recognition error that was not previously reported but is now desired by the user to be reported, the reporting dialog 302 may return to the choose error page (FIG. 5) to display ink samples. The ink samples that were already submitted are indicated on the choose error page.

As another example of a user option, a user may also select a user dialog control element 1303 to personalize handwriting recognition. By selecting the user dialog control element 1303 to personalize handwriting recognition, a personalization dialog may be launched. By providing personalization, the system may be able to better identify writing patterns or other features of the particular user to more accurately provide handwriting recognition. Additional follow-up topics may also be presented to the user.

The user may exit the reporting dialog by selecting a user dialog control element 1304 such as a “close” button 1304. If the system is still processing handwriting recognition errors or generating or transmitting a handwriting recognition error report when the user attempts to close the dialog, a cancellation dialog may appear. This dialog may, for example, advise the user of work in progress that might be lost. FIG. 14 shows a cancellation dialog 1401 which may be displayed under certain conditions. For example, if the user attempts to terminate the dialog by selecting the “cancel” button 705 in FIG. 7, the cancellation dialog window 1401 appears allowing the user an opportunity to confirm termination of the dialog. The user may cancel the termination of the dialog by selecting user dialog control element 1402 corresponding to canceling the termination of the dialog (e.g., a cancel button). Alternatively, the user may proceed with termination of the dialog by selecting a user dialog control element 1403 corresponding to acknowledging termination of the dialog.

Included at the end of this detailed description are Appendices A though H describing functions, notifications, messages and structures, according to at least some embodiments, by which an application may cause the display of a series of task pages for the management or reporting of handwriting recognition errors. Because Appendices A through H will be readily understood by persons skilled in the art, they will not be extensively discussed herein. As can be seen in said appendices, however, various other messages and notifications can be exchanged as part of a process similar to the example of FIGS. 4 through 14.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Appendix A

WerReportCreateo

HRESULT WerReportreate(IN PCWSTR pwzEventame, WER_REPORT_TYPE repType, WER_REPORT_OPTIONS* pReportOptions, OUT HREPORT* pReportHandle)

Description

WerReportCreate( ) is used by a vertical to initiate the reporting process.

Parameters

| Parameter | Description |
|---|---|
| pwzEventName | Event name. This name must be registered on the |
| | server else the report will be ignored. The default |
| | consent keys will be used unless a different key is |
| | provided (see optional parameters below). |
| repType | Identifies the type of the report: |
| | WerReportCritical - Crashes, hangs will be critical |
| | errors. These event types will be archived. By |
| | default these processes will be terminated or |
| | restarted. |
| | WerReportNonCritical - Other errors, these may |
| | not be archived. These processes are not |
| | terminated or restarted. (Default) |
| pReportOptions | Pointer to a populated report options structure. NULL |
| | if you have no options. |
| pReportHandle | This will contain the report handle. This is returned as |
| | NULL if any errors occur. |

Return Values

| Value | Description |
|---|---|
| S_OK | Success |
| E_INVALIDARG | Invalid event name |
| E_OUTOFMEMORY | Out of memory |
| E_PERMISSIONDENIED | Cannot create report |
| | if policy controlling WER is 0 |
| | (Error Reporting Disabled) |

Report Options Structure

| Field | Description |
|---|---|
| dwSize | The size of this structure. |
| hProcess | Handle of the process that the report is regarding. |
| | OPTIONAL: If passed as NULL, WER will use |
| | the calling process context. |
| wzFriendlyEventName | This will also be used to identify the report in the |
| | Reporting Console. Defaults to the |
| | value specified in |
| | pwzEventName if null. |
| wzConsentKey | Name used to lookup consent |
| | settings. Defaults to the value |
| | specified in pwzEventName if null. |
| wzApplicationPath | Full path to the application. For crashes and |
| | hangs this will be the name of the |
| | crashing/hanging application. |
| | For generic reports this will be the name of |
| | the application that is creating |
| | it. WER will attempt to |
| | discover this if it is passed as empty. |
| wzDescription | A short 2-3 sentence description (512 character |
| | maximum) of the problem. This description is |
| | displayed in the report details in the Reporting |
| | Console. |

typedef struct _WER_REPORT_OPTIONS
{

| | |
|---|---|
| DWORD | dwSize; |
| HANDLE | hProcess; |
| WCHAR | wzFriendlyEventName[256]; |
| WCHAR | wzConsentKey[128]; |
| WCHAR | wzApplicationPath[MAX_PATH]; |
| WCHAR | wzDescription[512]; |

} WER_REPORT_OPTIONS, *PWER_REPORT_OPTIONS;

Appendix B
WerReportAddDump( )
HRESULT WerReportAddDump(IN HREPORT hReportHandle, IN DWORD dwDumpFlavor, IN HANDLE hProcess, IN HANDLE hThread, IN PERCEPTION_CUSTOM_OPTIONS pDumpCustomOptions, IN BOOL bCollectAlways)
Description

Adds a dump to a report and sets the options and flags for the generation of that dump.

Parameters

| Parameter | Description |
|---|---|
| hReportHandle | The report handle returned |
| | from WerReportCreate. |
| dwDumpFlavor | One of the following: |
| | Microdump |
| | Minidump |
| | Fulldump |
| | Custom |
| hProcess | Handle to the process for which the information is |
| | to be generated. This handle must have read |
| | and query access. |
| hThread | Handle of the specific thread in the process |
| | to collect on. |
| pDumpCustomOptions | This can be used to customize any minidump that |
| | will be collected. If the value of this |
| | parameter is NULL, then a |
| | standard minidump is collected. |
| bCollectAlways | If TRUE always collects this dump. If FALSE |
| | collects only if the server requests the dump. |

Return Values

| Value | Description |
|---|---|
| S_OK | Success |
| E_FAIL | Some unexpected error occurred |
| E_HANDLE | Invalid Report Handle |
| E_INVALIDARG | Invalid argument |

Custom Options Structure

| Field | Description |
|---|---|
| dwSize | The size of this structure. |
| dwMask | Bit mask to control which options are |
| | valid in the structure. |
| dwMinidumpType | The type of the minidump. |
| | This is an ORing of |
| | MINIDUMP_TYPE |
| bDisableHeap | Do not collect heap. |
| pExceptionParam | Pointer to a |
| | MINIDUMP_EXCEPTION_{—} |
| | INFORMATION |
| | structure describing the client exception that |
| | caused the minidump to be generated. If this |
| | parameter is NULL (default), no exception |
| | information is included in the minidump file. |
| bOnlyThisThread | Whether the dump has to be collected only |
| | for this thread |
| dwExceptionThreadFlags | The flags for the thread that |
| | encountered the exception |
| dwExceptionThreadExFlags | Extra dump flags for the thread |
| | encountering the exception |
| dwOtherThreadFlags | Thread flags for threads other than the thread |
| | encountering the exception |
| dwOtherThreadExFlags | Extra dump flags for the any other thread |
| | (threads that did not encounter the exception) |
| dwPreferredModuleFlags | Module Flags for the crashing application, |
| | crashing module or any modules present in |
| | wzExtraModuleList |
| dwOtherModuleFlags | Module flags for other modules |
| wzPreferredModuleList | List of modules for which we want to |
| | customize dump generation. |
| | The dwPreferredModuleFlags |
| | will apply to these as well. Each name |
| | must be NULL terminated with the list being |
| | double NULL terminated. |

typedef struct _EXCEPTION_CUSTOM_OPTIONS
{

| | |
|---|---|
| DWORD | dwSize; |
| DWORD | dwMask; |
| DWORD | dwMinidumpType; |

| PMINIDUMP_EXCEPTION_INFORMATION pExceptionParam, | |
|---|---|
| BOOL | bOnlyThisThread; |

| | |
|---|---|
| DWORD | dwExceptionThreadFlags; |
| DWORD | dwOtherThreadFlags; |
| DWORD | dwExceptionThreadExFlags; |
| DWORD | dwOtherThreadExFlags; |
| DWORD | dwPreferredModuleFlags; |
| DWORD | dwOtherModuleFlags; |

WCHAR wzPreferredModuleList[WER_MAX_MODULES];

} EXCEPTION_CUSTOM_OPTIONS,
*PEXCEPTION_CUSTOM_OPTIONS;

Mask Values

WER_MASK_MDUMPTYPE
WER_MASK_DISABLE_HEAP
WER_MASK_EXCEPTION_INFORMATION
WER_MASK_ONLY_THISTHREAD
WER_MASK_THREADFLAGS
WER_MASK_OTHER_THREADFLAGS
WER_MASK_THREADFLAGS_EX
WER_MASK_OTHER_THREADFLAGS_EX
WER_MASK_PREFERRED_MODULESFLAGS
WER_MASK_OTHER_MODULESFLAGS
WER_MASK_MODULE_LIST

Appendix C
WerReportSetParameter( )
HERSULT WerReportSetParameter(IN HREPORT hReportHandle, IN WER_PARAM ID, IN PCWSTR pwzName, IN PCWSTR pwzValue)
Description

This API is used to set the reporting signature: the set of parameters that will uniquely identify a particular event. A separate call needs to be made for each parameter. A valid signature consists of valid values for WerP0 . . . WerP10. The check to ensure that a signature is valid is done during WerReportSubmit.

Parameters

| Parameter | Description |
|---|---|
| hReportHandle | The report handle returned from WerReportCreate |
| ID | This represents the parameter enumeration which we are |
| | setting. Values will be WerP0, WerP1, etc. Parameters |
| | need not be specified in order. |
| pwzName | Optional name of the parameter. This can be NULL, in |
| | these cases Px will be used where x is the index of the |
| | parameter. |
| pwzValue | This will be the value of the parameter that we are setting |

Return Values

| Value | Description |
|---|---|
| S_OK | Success |
| E_OUTOFMEMORY | Out of memory error |
| | while adding the parameter |
| E_INVALIDARG | Bad parameter ID or NULL Param |
| | Value |
| E_HANDLE | Bad Report Handle |
| WER_E_LENGTH_EXCEEDED | Length exceeded. Adding the |
| | parameter will cause |
| | the parameter data storage |
| | to overflow and it may |
| | be trimmed. |
| E_FAIL | Some unexpected |
| | error occurred |

Appendix D
WerReportAddSecondaryParameter( ) [Optional]
HRESULT WerReportAddSecondaryParameter(IN HREPORT hReportHandle, IN PCWSTR pwzName, IN PCWSTR pwzValue)
Description

Optionally adds a set of NAME-VALUE pairs along with the report signature. This API is commonly used to add Brand and custom query parameters to the report.

Parameters

| Parameter | Description |
|---|---|
| hReportHandle | The report handle returned from |
| | WerReportCreate. |
| pwzName | The name of the key to add. |
| pwzValue | Corresponding value of the key |

Return Values

| Value | Description |
|---|---|
| S_OK | Success |
| E_OUTOFMEMORY | Out of memory error |
| | while adding the parameter |
| E_FAIL | Some unexpected error occurred |
| WER_E_LENGTH_EXCEEDED | Length exceeded. Adding the key |
| | value pair will |
| | cause the secondary |
| | parameter data storage |
| | (including primary parameters) |
| | to overflow and it |
| | will be truncated. |
| E_HANDLE | Invalid report handle |
| E_INVALIDARG | If key or value is NULL. |

Appendix E
WerReportAddFile( )

HRESULT WerReportAddFile(IN HREPORT hReportHandle, IN PCWSTR pwzPath, IN WER_FILE_TYPE repFileType, IN DWORD dwFileFlags)

Parameters

| Parameter | Description |
|---|---|
| hReportHandle | The report handle returned from WerReportCreate |
| pwzPath | Complete path to the file that needs to be added. The |
| | path can contain environment variables. |
| repFileType | This is used to describe the contents of |
| | the file being added. |
| | This can be one of |
| | WerFileTypeMinidump - Minidump file |
| | WerFileTypeHeapdump - Heap dump file |
| | WerFileTypeUserDocument - Contents of some user |
| | document like a .doc file |
| | WerFileTypeOther - File that fall under this category |
| | will be uploaded whenever a 2^{nd} Level data request is |
| | made |
| dwFileFlags | This is used to define what action should be taken for the |
| | file once it is added to the report: |
| | WER_DELETE_FILE_WHEN_DONE |
| | WER_ANONYMOUS_DATA |
| | Denotes that this is “safe 2^{nd} level” data |

Return Values

| Value | Description |
|---|---|
| S_OK | Success |
| E_OUTOFMEMORY | Out of memory error while |
| | adding the parameter |
| E_FAIL | Some unexpected error occurred |
| E_FILENOTFOUND | Invalid path to file |
| E_ACCESSDENIED | File cannot be read |
| E_HANDLE | Invalid report handle |

APPENDIX F
WerReportSetUIOption( ) [Optional]

HRESULT WerReportSetUIOptions(IN HREPORT hReportHandle, IN PCWSTR pwzValue)

Parameters

| Parameter | Description |
|---|---|
| hReportHandle | The report handle returned |
| | from a successful call to |
| | WerReportCreate. |
| pUIOptions | Pointer to a populated UI options structure. |

Return Values

| Value | Description |
|---|---|
| S_OK | Success |
| E_INVALIDARG | Invalid structure field or report handle. |
| E_OUTOFMEMORY | Out of memory |

Report Options Structure

| Field | Description |
|---|---|
| dwSize | The size of this structure. |
| dwMask | Bit mask to control which options are valid in |
| | the structure. |
| wzMoreInfoLinkText | Text to display for the more info link |
| | (required if LinkURI specified) |
| wzMoreInfoLink | URI for the more info link. The URI is limited |
| | to the following protocols: |
| | http:// |
| | https:// |
| | res:// |
| | help:// |
| | (required if LinkText specified) |
| wzDiagnosisHeading | Heading of the diagnosis panel. |
| wzDiagnosisDescription | Description of the diagnosis panel. |

typedef struct_WER_UI_OPTIONS
{

| | |
|---|---|
| DWORD | dwSize; |
| WCHAR | wzMoreInfoLinkText[256]; |
| WCHAR | wzMoreInfoLink[512]; |
| WCHAR | wzDiagnosisHeading[256]; |
| WCHAR | wzDiagnosisDescription[512]; |
| WCHAR | wzDiagnosisRecoveryHeading[256]; |
| WCHAR | wzDiagnosisRecoveryDescription[512]; |

} WER_UI_OPTIONS, *PWER_UI_OPTIONS;

Mask Values

WER_MASK_MORE_INFO_TEXT
WER_MASK_MORE_INFO_LINK
WER_MASK_DIAG_HEADING
WER_MASK_DIAG_DESC
WER_MASK_DIAGRECOVERY_HEADING
WER_MASK_DIAGRECOVERY_DESC

APPENDIX G
WerReportSubmit( )
HRESULT WerReportSubmit(IN HREPORT hReportHandle, IN DWORD dwConsentResult, IN DWORD dwFlags, OUT PWER_SUBMIT_SUCCESSCODE pSucessCode)
Description

This will initiate the sending of the report. WerReportSubmit( ) returns when the report has been inserted into a queue.

Parameters

| Parameter | Description |
|---|---|
| hReportHandle | The report handle returned from WerReportCreate. |
| dwConsentResult | This indicates that prior to report being submitted, the caller |
| | has already attempted to get 1^{st} level consent from the user |
| | and gotten back the specified consent result. This consent |
| | must include permission to send 1^{st} level parameters and |
| | caller specified files. One of: |
| | WerConsentNotAsked |
| | Indicates the caller did not obtain consent resulting in the |
| | normal consent evaluation and experience. |
| | WerConsentAskedDenied |
| | Indicates the caller attempted to obtain consent the user denied the |
| | request. |
| | WerConsentAskedApproved |
| | Indicates the caller attempted to obtain consent, and the |
| | user agreed to sending 1^{st} level data and the current contents of the CAB. |
| | WerConsentAskedShowConsentDialog |
| | Indicates the caller obtained interest from the user for |
| | sending a report but not consent. The consent dialog will |
| | appear to obtain consent provided the current settings |
| | don't allow the report to be sent automatically. |
| dwFlags | Combination of one or more of the following flags: |
| | WER_REPORT_HONOR_RECOVERY |
| | Honor any recovery registration for the application. |
| | WER_REPORT_HONOR_RESTART |
| | Honor any restart registration for the application. |
| | WER_REPORT_QUEUE |
| | Forces report to be queued to disk instead of being |
| | uploaded. |
| | WER_REPORT_CRITICAL_NO_TERMINATE_RESTART |
| | Does not terminate or restart the failed process. Instead |
| | returns the action the vertical should take. Default |
| | behavior is to terminate or restart the reported process if |
| | the report is critical. This flag is ignored if repType is set |
| | to WerReportNonCritical. |
| pSuccessCode | The extended success code. One of: |
| | WerReportQueued |
| | WerReportResultUploaded |
| | WerDebug |
| | WerReportFailed |

Return Values

| Value | Description |
|---|---|
| S_OK | Success |
| E_OUTOFMEMORY | Out of memory error while submitting the |
| | report |
| E_INVALIDARG | Invalid argument |

APPENDIX H
WerReportCloseHandle( )
HRESULT WerReportCloseHandle(IN HREPORT hReportHandle)
Description

This will close the report handle and terminate error reporting. It will also free the memory associated with the report.

Parameters

| Parameter | Description |
|---|---|
| hReportHandle | The report handle returned from |
| | WerReportCreate. |

Return Values

| Value | Description |
|---|---|
| S_OK | Success |
| E_FAIL | Some unexpected error occurred |
| E_HANDLE | Invalid Report Handle |

1. A computer-readable medium having stored thereon data representing sequences of instructions which, when executed by a processor, cause the processor to perform steps of a method for reporting handwriting recognition errors in a computer system, the method comprising:
receiving a request from a user to display a report initiation dialog;
receiving a selection of at least one handwriting recognition error stored with one or more other handwriting recognition errors;
generating a report containing the selected at least one handwriting recognition error.

2. The computer-readable medium of claim 1, comprising further instructions for performing the step of transmitting the report to a another computer system.

3. The computer-readable medium of claim 1, comprising further instructions for performing the steps of:
receiving ink input;
receiving a user correction to a recognized result corresponding to the ink input;
storing the recognized result corresponding to the ink input on a queue.

4. The computer-readable medium of claim 3 wherein the storing comprises storing values of at least one parameter, the at least one parameter being selected from the group consisting of a parameter having values corresponding to a globally unique identifier (GUID), a parameter having values corresponding to a version of an operating system, a parameter having values corresponding to a recognizer developer, a parameter having values corresponding to an input panel skin indicating a mode of a Tablet PC Input Panel, a parameter having values corresponding to an input scope indicating a type of input, a parameter having values corresponding to recognized text, a parameter having values corresponding to corrected text, a parameter having values corresponding to a version of an operating system, a parameter having values corresponding to an operating system software module, a parameter having values corresponding to an input LCID indicating operating system settings based on geographical location, a parameter having values corresponding to handedness of a user, a parameter having values corresponding to a phrase list count; a parameter for indicating if a text string is found in a dictionary, a parameter for indicating personalization data, and a parameter for indicating a user supplied comment.

5. The computer-readable medium of claim 3 wherein the at least one parameter comprises a parameter for indicating recognized text and a parameter for indicating corrected text.

6. The computer-readable medium of claim 1, comprising further instructions for performing the steps of:
providing a list of reportable handwriting recognition errors, each of the handwriting recognition errors including an ink sample and recognized text corresponding to the ink sample; and
receiving the selection of the at least one handwriting recognition error from the provided list.

7. The computer-readable medium of claim 1, comprising further instructions for performing the step of receiving a modification of the corrected text corresponding to the selected ink sample.

8. The computer-readable medium of claim 1, comprising further instructions for performing the steps of:
displaying a control element corresponding to the selected at least one handwriting recognition error; and
verifying, in response to selection of the control element that the selected handwriting recognition error is to be included in the report.

9. The computer-readable medium of claim 1, comprising further instructions for performing the step of displaying a list of values of multiple parameters, the values being associated with the selected handwriting recognition error, the parameters including at least one of a parameter corresponding to an ink sample, a bucketing parameter, an XML file parameter, and a parameter corresponding to a user comment.

10. The computer-readable medium of claim 1, comprising further instructions for performing the steps of:
displaying a comment dialog;
receiving a comment from a user via the comment dialog,
wherein the generating step includes generating the report so as to include the comment.

11. The computer-readable medium of claim 6, comprising further instructions for performing the steps of:
receiving a selection of a user dialog control element; and
transmitting a handwriting recognition error report responsive to receiving the selection of the user dialog control element, the handwriting recognition error report including the at least one selected handwriting recognition error.

12. A method for tracking handwriting recognition errors in a computer system, the method comprising:
receiving an ink input from a user;
converting the ink input to recognized digital text;
receiving a correction of the recognized digital text; and
storing the received correction with previously received corrections.

13. The method of claim 12 wherein the storing step further comprises storing with each correction values for a plurality of categorization parameters.

14. The method of claim 13 wherein the categorization parameters are selected from the group consisting of a parameter having values corresponding to a globally unique identifier (GUID), a parameter having values corresponding to a version of an operating system, a parameter having values corresponding to a recognizer developer, a parameter having values corresponding to an input panel skin indicating a mode of a Tablet PC Input Panel, a parameter having values corresponding to an input scope indicating a type of input, a parameter having values corresponding to recognized text, a parameter having values corresponding to corrected text, a parameter having values corresponding to a version of an operating system, a parameter having values corresponding to an operating system software module, a parameter having values corresponding to an input LCID indicating operating system settings based on geographical location, a parameter having values corresponding to handedness of a user, a parameter having values corresponding to a phrase list count; a parameter for indicating if a text string is found in a dictionary, a parameter for indicating personalization data, and a parameter for indicating a user supplied comment.

15. The method of claim 12 wherein the step of storing the received correction further includes storing the corresponding ink input and the recognized digital text.

16. The method of claim 12 further comprising:
receiving a request from the user to display a report initiation dialog;
displaying the stored received correction responsive to receiving the request to display the report initiation dialog; and
receiving a selection of at least one of the displayed corrections.

17. The method of claim 16 wherein the step of displaying the stored received correction includes displaying the ink input, the recognized digital text, and the corrected digital text.

18. The method of claim 17 further comprising receiving input from the user verifyng selected handwriting recognition errors to be included in an error report.

19. The method of claim 18 further comprising transmitting the error report, the error report including ink input, recognized digital text and corrected digital text corresponding to selected and verified handwriting recognition errors.

20. The method of claim 12 further comprising:
receiving a selection of received corrections;
transmitting the selected received corrections in an error report; and
categorizing the transmitted selected received corrections based on categorization parameters.
